(19) United States
(12) Patent Application Publication
(10) Pub. No.: US 2002/0084393 A1
(43) Pub. Date: Jul. 4, 2002

(54) Sports equipment support apparatus

(76) Inventor: Jesus Torres, Montgomery, IL (US)

Correspondence Address: Pyle & Piontek, Suite 850, 221 N. LaSalle St., Chicago, IL, 60601, US

(21) Appl. No.: 09/752,185

(22) Filed: Dec. 29, 2000

(51) Int. Cl. F16B 1/00

(52) U.S. Cl. 248/230.8

(57) ABSTRACT

A sports equipment support apparatus has a flexible spine member with a plurality of individual support members thereon. The preferred support apparatus of the invention is adapted for attachment to a boxing ring corner post, and for supporting equipment useful for boxing such as waster bottles, towels and the like.

### FIELD OF THE INVENTION

The present invention is related to apparatuses for supporting sports equipment such as sports bottles, towels and the like.

### BACKGROUND OF THE INVENTION

In sports such as boxing, ready access to support equipment such as sports bottles and towels is required. A boxer between rounds will have a limited time in which he will drink water or a sports fluid from a sports bottle, and may have sweat or blood washed from his face with water squirted from a sports bottle and wiped with a towel. The quicker a “corner man” can accomplish these tasks the better.

In order to do all these things quickly, the corner man needs quick and organized access to equipment such as sports bottles and towels. Presently, the bottles and towels must be carried manually or laid about on the floor of a boxing ring where they are want to be kicked or otherwise disadvantageously moved about. Or the bottles may be laid on the floor away from the ring in order to be free from being stumbled on or otherwise disturbed. To do so, however, disadvantageously makes the bottles and towels difficult to access.

Also, the sport of boxing involves boxers regularly traveling to engage in matches. Boxers travel to other gyms or arenas for matches. Thus to be useful, sports equipment holders must be portable in nature and able to be set up and broken down quickly and easily.

Methods to removably store and organize equipment such as sports bottles have been proposed. In particular, corner men have carried the equipment about in trays or boxes. Use of such trays or boxes, however, means that the comer man's hands are filled when entering and exiting the ring. This causes difficulty and delay in that boxing rings are typically elevated and have ropes surrounding them that make entry and exit difficult even with hands free. Further, use of such trays does not solve a clutter problem, in that the trays must be stored somewhere during rounds in between use. Often this results in the trays being placed on the ring floor, resulting in clutter.

Several heretofore unresolved needs therefore exist in the art.

### OBJECTS OF THE INVENTION

It is an object of the invention to provide a sports equipment holder for storing sports equipment.

It is a further object of the invention to provide a boxing equipment holder adapted to be supported on a boxing ring post for storing sports equipment comprising a plurality of sports drink bottles and a towel.

### SUMMARY OF THE INVENTION

The present invention generally comprises a sports equipment holder for supporting sports equipment on a vertical support, with the equipment holder comprising a flexible spine member having two ends, with each of the two ends having attachment means for attaching to the other of the two ends about the perimeter of the vertical support, and at least a first storage container adjustably hold on the flexible spine, the storage container adapted for storing sports equipment. Preferably at least a first storage container comprises a plurality of storage containers.

In a preferred embodiment of the sports equipment holder of the present invention, the flexible spine member comprises a strap for wrapping about the perimeter of a boxing ring post. This preferred embodiment further comprises at least a suspender strap for passing over the top of the ring post, the suspender strap attached at both ends to the flexible spine strap.

The above brief description sets forth rather broadly the more important features and advantages of the present disclosure so that the detailed description that follows may be better understood, and so that the present contributions to the art may be better appreciated. There are, of course, additional features of the disclosure that will be described hereinafter which will form the subject matter of the claims appended hereto. In this respect, before explaining the embodiment of the disclosure in detail, it is to be understood that the disclosure is not limited in its application to the details of the construction and the arrangements set forth in the following description or illustrated in the drawings. The present invention is capable of other embodiments and of being practiced and carried out in various ways, as will be appreciated by those skilled in the art. Also, it is to be understood that the phraseology and terminology employed herein are for description and not limitation.

### BRIEF DESCRIPTION OF THE DRAWINGS

FIG. 1 is a top plan view of a first embodiment of the sports equipment holder of the present invention encircling a post (shown in dashed).

FIG. 2 is a side elevational view of sports bottle holder with the flexible strap passing through the holder of the first embodiment of the equipment support of the invention.

FIG. 3 is a perspective view of a second embodiment of the sports equipment holder of the present invention.

FIG. 4 is a perspective view of a second embodiment of the sports equipment holder of the invention installed on a post (in dashed).

FIG. 5 is an exploded perspective of the suspender straps of the second embodiment of Fig.

FIG. 6 is an exploded perspective of the suspender strap distal end being attached to the spine strap.

FIG. 7 is a perspective view of a towel hook of an embodiment of the sports equipment holder of the invention.

FIG. 8 is a perspective view of a spring bracket of an embodiment of the sports equipment holder of the invention.

FIG. 9 is a perspective view of a flexible sports bottle holder of an embodiment of the sports equipment holder of the invention.

### DETAILED DESCRIPTION

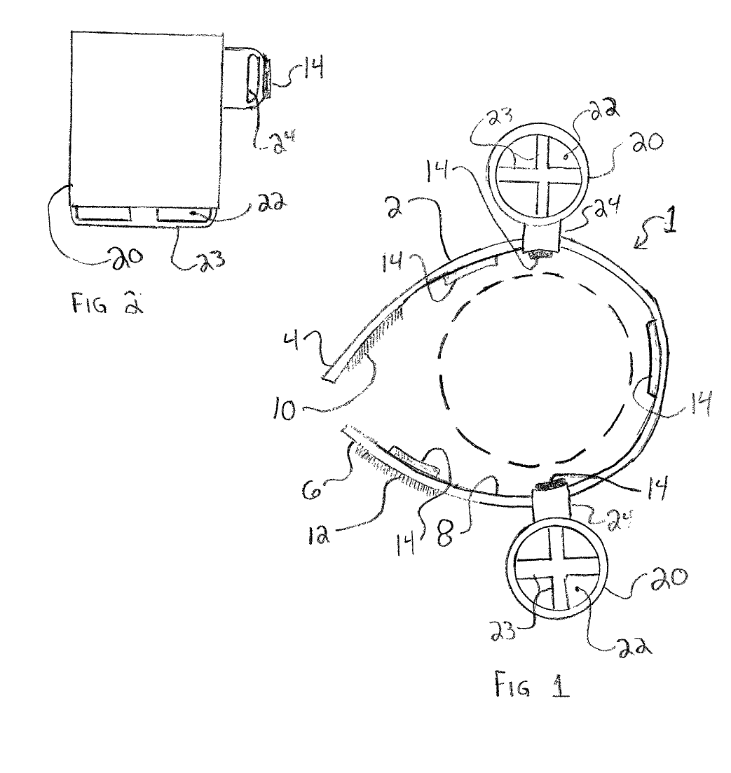

Turning now to the drawings, FIG. 1 is a top plan view of a first embodiment of the sports equipment holder 1 of the present invention. The equipment holder generally comprises a flexible spine member 2 having two ends 4 and 6, and an inside surface 8. End 4 has a plurality of hooks 10 on its inside surface for mating with a plurality of loops 12 on the outside surface of and 6 for fastening equipment holder one about a post (shown in dashed). Mating hooks and loops 10 and 12 are known in the art, and may comprise any of a variety of commercially available products, including but not limited to Velcro.

Other means in addition to hooks and loops 10 and 12 may of course be comprised within the scope of the invention and claims attached hereto. By way of example and not limitation, a frictional buckle could be used. Because boxing ring posts are of different perimeter sizes, it is preferable that means such as a frictional buckle or Velcro be used so that the flexible spine strap may be attached in varying lengths.

At least a portion of the spine strap inside surface 8 also preferably comprises an anti-friction pad for frictionally engaging the post. Most preferably, a plurality of friction pads 14 are attached with adhesive or stitching to strap inside surface 8. Friction pads 14 are preferably comprised of a soft, high friction material such as rubber, neoprene, or similar flexible polymer material. It has been discovered that a plurality of friction pads 14 are preferred over a single pad extending over a substantial portion of strap inside surface 8. In particular, it has been discovered that a single pad 14 may disadvantageously decrease flexibility of strap 2, while a plurality of individual pads, on the other hand, allows strap 2 to advantageously flex freely.

Strap 2 supports a plurality of sports bottle holders 20, shown in an elevational view in FIG. 2. A first embodiment of sports bottle holders 20 are comprised of rigid plastic, with a plurality of apertures 22 in its base formed between cross members 23. Apertures 22 are useful for allowing liquids to drain from holder 20. Channel 24 passes strap 2 therethrough for attaching holder 20 to strap 2. Because channel 24 passes strap therethrough, it has been discovered that attaching a friction pad 14 to channel surface 26 is most advantageous. Because sports bottles may be of substantial weight when filled, they may place a significant load on strap 2. Friction pads 14 on inside surface of channel 24 advantageously place some of this load directly on the post through frictional contact instead of strap 2.

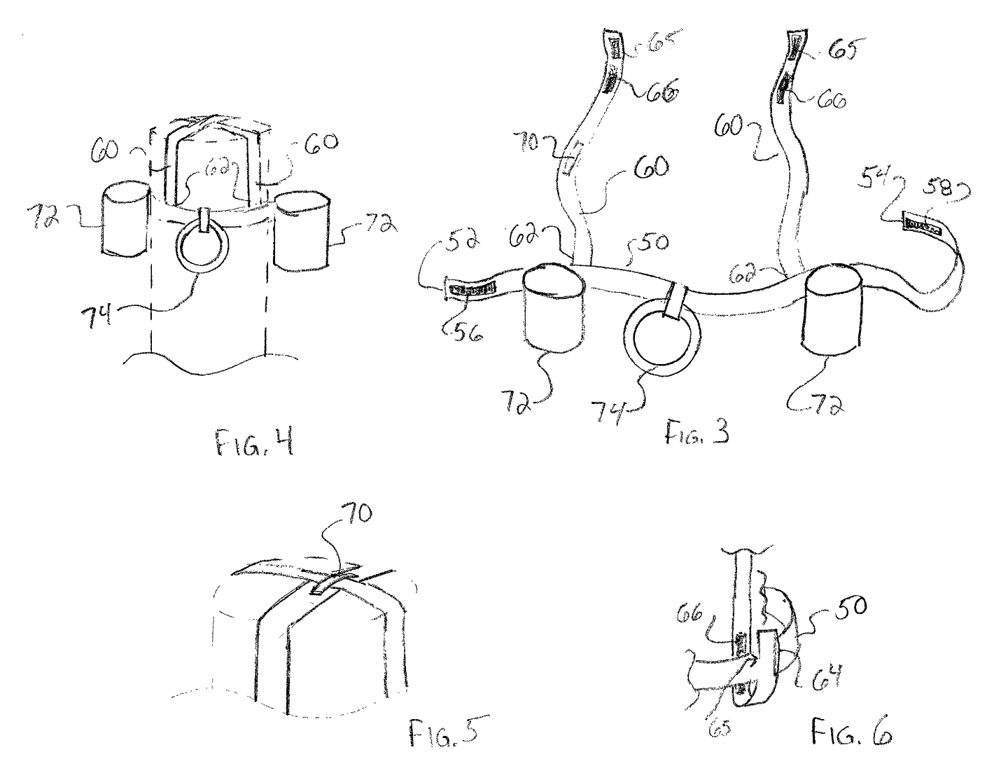

FIGS. 3 and 4 are perspectives of a second embodiment of the sports equipment holder of the invention. It comprises flexible spine strap 50 having two ends 52 and 54. Ends 52 and 54 have mating sections of hooks 56 and loops 58 for adjustably fastening strap 50 about the perimeter of a post (shown in FIG. 4 in dashed).

A plurality of suspender straps 60 are attached to spine strap 50. Suspender straps 60 have first ends 62 preferably fixedly attached to spine 50 by stitching, adhesive, or the like. As best illustrated by the exploded view of FIG. 6, suspender straps 60 have distal ends 64 for removable attachment to spine strap 50 after passing over the top of a post. Distal and 64 preferably has a section of mating hooks 65 and loops 66 for attaching end 64 to spine member 50.

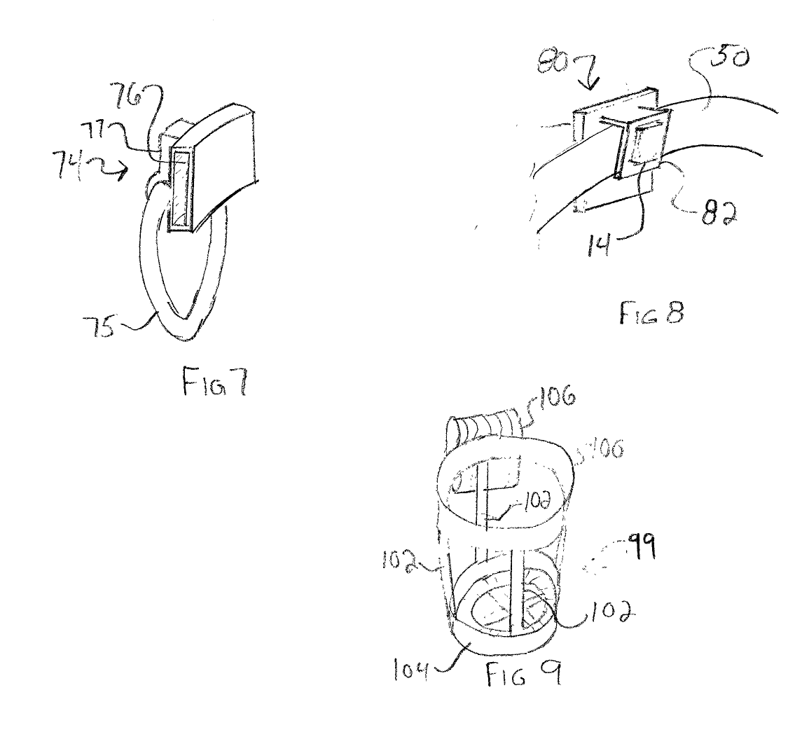

As best illustrated by FIGS. 4 and 5, suspender straps 60 cross one another at a substantially perpendicular orientation to one another. As best illustrated by the exploded view of FIG. 5, one of the suspender straps 60 has a channel 70 formed on its outer surface for passing the other suspender strap 60. Preferably, channel 70 is formed from the same flexible material as strap 60, which may comprise nylon. Suspender straps 60 each also preferably comprise at least one friction pad 14 on their inner surfaces for frictionally engaging the post, as generally illustrated in the embodiment of FIG. 1.

Suspender straps 60 are advantageous for supporting the equipment holder of the invention when particularly heavy loads are carried. Should the equipment holder be used, for instance, to store four or five filled sports drink bottles, flexible spine strap 50 may not be sufficient for support. It has been discovered that suspender straps 60 advantageously provide required support in such situations. As an additional example, should a towel be stored on loop 74 and very quickly pulled out, single spine strap 50 may loosen somewhat and eventually slip or disengage from the post. Suspender strap 60 advantageously minimize the occurrence of such loosening.

Also, it will be appreciated by those knowledgeable in the art that although FIGS. 3-5 illustrate a sports equipment holder having two suspender straps 60, other embodiment of the equipment holder of the invention within the scope of the appended claims may comprise fewer or more suspender straps 60. By way of example only, the sports equipment holder may comprise only a single suspender strap 60, or may comprise three suspender straps 60.

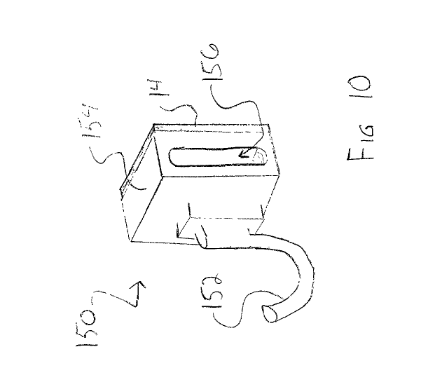

FIGS. 3 and 4 illustrate a plurality of sports equipment holders supported by strap 50 in the second embodiment of the holder of the invention. In particular, a plurality of sports bottle holders 72 are supported in addition to a towel loop 74. Towel loop 74 is adapted for storing a towel, much in the way that residential bathrooms may have a loop for hanging a towel. Loop 72 is preferably comprised of resilient low weight material, such as plastic. As illustrated in the perspective view of FIG. 7, loop 74 comprises a channel 76 through which strap 50 may pass. Loop 75 movably is held by loop holder mount 77. Sports bottle holders 72 are generally as described with reference to the first embodiment of the equipment holder of the invention.

Alternate mounting means for sports bottle holders 72 and towel loop 74 comprise bracket clip 80 as illustrated in FIG. 8. Bracket clip 80 may be preferred for the second sports equipment holder embodiment of the invention, in order to allow the respective bottle holder 72 or towel loop 74 to be hung on any portion of strap 50, including the center portion between suspender straps 60 where a channel mounting method will not be able to be removed. Preferably, bracket clip 80 comprises a spring loaded clip arm 82 for springingly engaging flexible spine strap 50. Further, the inside surface of loaded clip arm 82 comprises friction pad 14 for frictionally engaging a post.

In addition to the sport drink bottles holders 20 and 72, and the towel loop 74 illustrated and discussed above, the sports equipment holder of the invention may further comprise one or more utility hooks supported from the flexible spine strap for holding boxing gloves, a towel, or the like.

The first embodiment of the equipment holder of the invention, or the second embodiment utilizing towel loop 74 and bottle holders 72 may be provided for sale in kit form with a plurality of holders 72 and loops 74. The equipment holder may thereby be configured as desired by the user to include any practical combination of loops 74 and holders 72. By way of example, the holder may comprise from one to four or five loops 74 alone, from one to three or four bottle holders 72, or may comprise a combination of loops 74 and holders 72. In addition, the kit could comprise from one to a mutliplicity of utility hooks.

FIG. 9 illustrates an additional embodiment of sports bottle holder 20 or 72 of the invention. This embodiment comprises a substantially flexible and collapsible bottle holder 20. It comprises an upper flexible ring 100 connected by a plurality of flexible struts 102 to base 104. Upper ring 100, struts 102, and base 104 are all comprised of flexible, resilient material such as canvas, nylon, or other synthetic fiber material. Upper ring 100 is connected to channel 106 for passing strap 50. Channel 106 is preferably comprised of molded plastic, and is attached to ring 100 by stitching, adhesive, or other means. In addition to channel 106, bracket 80 of FIG. 8 may be used with flexible holder 100.

It has been discovered that flexible holder 100 is particularly advantageous for applications that require a lightweight, compact sports equipment holder. As an example, an equipment holder that must be frequently packed up and transported will benefit from a collapsible holder 100.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

What is claimed is:

1. A sports equipment holder for supporting sports equipment on a vertical support, the equipment holder comprising:
a) a flexible spine member, said flexible spine member having two ends, each of said two ends having attachment means for attaching to the other of said two ends about the perimeter of the vertical support; and
b) at least a first storage container adjustably held on said flexible spine, said storage container adapted to storing sports equipment.

2. A sports equipment holder as in claim 1, wherein said at least a first storage container comprises a plurality of storage containers.

3. A sports equipment holder as in claim 2, wherein said plurality of storage containers comprises at least a pair of sports bottle holders.

4. A sports equipment holder as in claim 2, wherein said plurality of storage containers comprises at least a pair of sports bottle holders and at least a ring for storing a towel.

5. A sports equipment holder as in claim 3 wherein said plurality of sports bottle holders are comprised of a flexible substantially horizontal upper ring, a flexible substantially lower ring, with at least a flexible strut connecting said upper and lower rings, and a channel connected to said flexible upper ring for passing said flexible spine member.

6. A sports equipment holder as in claim 1, wherein said flexible spine comprises a flexible strap having two ends, and wherein said attachment means comprise a plurality of hooks on a one of said two strap ends and a plurality of loops on the other of said two ends for mating with said hooks.

7. A sports equipment holder as in claim 1, wherein said flexible spine member having an inside surface, at least a portion of said inside surface covered with at least one friction pad for increasing frictional resistance with said vertical support.

8. A sports equipment holder as in claim 1, wherein the vertical support is a post, the post having a top; and wherein the equipment holder further comprises:
a) at least a first flexible suspender member, said first flexible suspender member having two ends and a center portion, said center portion passing over the post top, said two ends attached to said flexible spine member.

9. A sports equipment holder as in claim 8, wherein said at least a first flexible suspender member comprises first and second flexible suspender members, said second flexible suspender member having first and second ends with a center portion therebetween; said first and second ends attached to said flexible spine member with said center portion passing over the post top; said first flexible suspender member and said second flexible spine member oriented generally perpendicular to one another.

10. A sports equipment holder as in claim 9, wherein said first flexible suspender member center portion having an outside surface, a channel formed on said center portion outside surface for passing said second flexible suspender member through.

11. A sports equipment holder as in claim 9, wherein said flexible spine member, said first flexible suspender member, and said second flexible spine member all comprise straps.

12. A sports equipment holder as in claim 11, wherein said flexible spine strap, said first flexible suspender strap and said second flexible spine strap all have inside surfaces for engaging the post, at least a portion of each of said flexible spine strap, first flexible suspender strap and second flexible suspender strap inside surfaces having at least one friction pad for frictionally engaging the post.

13. A sports equipment holder for storing a plurality of sports bottles and a towel on a post, the post having a perimeter; the equipment holder comprising:
a) a flexible spine strap having two distal ends and an inside surface, one of said two distal ends having a plurality of loops with the other of said two distal ends having a plurality of hooks; said plurality of loops for mating with said plurality of hooks for removably attaching said distal ends to one another to removably attach said strap about the perimeter of the post; said flexible spine strap having an inside surface with a plurality of friction pads thereupon for frictionally engaging the post;
b) a plurality of sports drink bottle holders adjustably held on said flexible strap, each of said plurality of sports drink bottle holders for storing a sports bottle; and
c) at least a loop attached to said flexible spine strap for storing a towel.

14. A sports equipment storing apparatus for removably storing a plurality of sports bottles and a towel on a post, the post having a perimeter and a top; the apparatus comprising:
a) a flexible spine strap having two distal ends and an inside surface, one of said two distal ends having a plurality of loops with the other of said two distal ends having a plurality of hooks; said plurality of loops for mating with said plurality of hooks for removably attaching said disparate ends to one another to removably attach said strap about the perimeter of the post; a plurality of friction pads on said flexible strap inside surface for frictionally engaging the post;
b) a first suspender strap having a pair of distal ends, a center portion, an inside surface, and an outside surface; a first of said pair of distal ends fixedly attached to said flexible strap, the second of said pair of suspender strap distal ends having a mating set of hooks and loops for removably attaching said second distal end to said flexible strap with said suspender center portion passing over the post top; at least a portion of said first suspender strap inside surface having a friction pad for engaging the post; said first suspender strap center portion outer surface having a channel;
c) a second suspender strap having a pair of distal ends, a center portion, an inside surface, a first of said pair of distal ends fixedly attached to said flexible strap, the second of said pair of suspender strap distal ends having a set of mating hooks and loops for removably attaching said second distal end to said flexible strap with said suspender center portion passing over the post top; said second suspender strap oriented to said first suspender strap at an approximately perpendicular angle; said second suspender strap passing through said first suspender strap center portion outer surface channel; at least a portion of said second suspender strap inside surface having a friction pad for engaging the post;
d) a plurality of sports drink bottle holders adjustably held on said flexible strap, each of said plurality of sports drink bottle holders for storing a sports bottle; each of said sports drink bottle holders having a channel for passing said flexible spine strap therethrough; said channel having a post facing surface, a friction pad on said post facing surface for frictionally engaging the post; and
e) at least one loop attached to said flexible strap for storing the towel, said at least one loop having a channel for passing said flexible spine strap therethrough, said channel having a post facing surface, a friction pad on said post facing surface for frictionally engaging the post.
